(19) United States
(12) Patent Application Publication
(10) Pub. No.: US 2012/0088496 A1
(43) Pub. Date: Apr. 12, 2012

(54) FEMTO ACCESS POINT AND METHOD FOR AUTOMATICALLY SETTING AREA CODE

(75) Inventors: Ki-Ho Lee, Namyangju-si (KR); Hee-Jun Lee, Seoul (KR); Joong-Wan Park, Anyang-si (KR); Jong-Ho Park, Seongnam-si (KR)

(73) Assignee: KT CORPORATION, Seongnam-city (KR)

(21) Appl. No.: 13/266,384

(22) PCT Filed: Apr. 21, 2010
(86) PCT No.: PCT/KR10/02509

§ 371 Date: Dec. 29, 2011

(30) Foreign Application Priority Data
Apr. 27, 2009 (KR) 10-2009-0036580

(51) Int. Cl. H04W 4/00

(52) U.S. Cl. 455/422.1

(57) ABSTRACT

Provided is a method for automatically setting an area code by a femto access point (AP) located in a coverage area of a macro cell. The method includes receiving a broadcast signal of the macro cell, extracting an area code of the macro cell from the received broadcast signal, and setting the extracted area code as an area code of the femto cell. The femto AP sets the same area code as that of the macro cell as its area code and transmits the area code of the femto AP to the mobile station, thereby preventing the mobile station from repeating the location registration and enabling the mobile station to receive the same paging message from the femto AP and the macro cell.

### CROSS-REFERENCE TO RELATED APPLICATION

This application enters into the U.S. national phase based on International Application PCT/KR2010/002509, filed on Apr. 21, 2010, which claims the benefit under 35 U.S.C. 119(a) from Korean Patent Application No. 10-2009-0036580, filed on Apr. 27, 2009, the entire disclosure of which is incorporated herein by reference in its entirety.

### BACKGROUND

1. Field

The present invention relates to a femtocell technology, and in particular, to a method for automatically setting an area code by a femto access point (AP) of a femto cell, and a femto AP for the same.

2. Description of Related Art

A femtocell technology is a type of technology that provides a mobile communication service to a much smaller coverage area than the conventional mobile communication service coverage area via a femto access point (AP). A femto cell is mainly used as a means for a specific purpose, for example, for providing a low-cost communication service called a femto zone service, and is also used to ensure the quality of a mobile communication service in dead zone or in areas such as the inside of a home or building where radio waves of a macro cell deteriorates. A femto cell uses a universal Internet line to connect to a core network. Accordingly, a femto cell is advantageous in that it is moderate in price for installation and maintenance, and has high mobility since it can be installed in any area where an Internet line is installed.

As described above, a femto cell is mainly used to provide a special benefit, for example, a discount rate to a subscriber entering its coverage area. To provide a femtocell service, a femto AP as small as the size of a picture frame is used. The femto AP can either be installed directly by a subscriber who has purchased the femto AP in an electronics shop, or by an engineer of a communication service provider. In this context, there is an expectation that a femtocell service will be widely used in the future, which will consequently lead to the installation of femto APs all around.

However, when initially installing a macro base station which controls a macro cell or a femto AP which controls a femto cell, it needs to set an area code (a location area code (LAC) or a routing area code (RAC)) for each cell. The area code is used as a reference for registering a location of a mobile station and paging when delivering a call to the mobile station.

As described above, as the use of femtocell service is widely expanding, femto APs will be installed in many areas, for example, houses, offices, and the like. Accordingly, there exists a hassle for mobile communication subscribers having to repeatedly set an area code to a femto AP whenever initially installing the femto AP. Of course, a default area code may be set during the manufacturing of the femto AP, however, in this case, there is a possibility that the default area code may be different from an area code of a macro base station covering a coverage area of the femto AP.

When an area code of a femto AP is different from that of a macro base station, a mobile station repeats the location registration whenever the mobile station enters a coverage area of the femto AP. Generally, since a femto AP has a small coverage area, a mobile station can move between coverage areas of a femto AP and a macro base station at any time. In this instance, if an area code of a femto AP is different from that of a macro base station, a mobile station needs to repeat the location registration, which may cause a system load. Taking into consideration the number of femto APs installed throughout the country, this may cause a large load on mobile communication systems on the whole.

The present invention is designed to solve these problems, and it is an object of the invention to provide a femto AP located in a coverage area of a macro cell that automatically sets its area code based on an area code of the macro cell, and a method for automatically setting an area code by the femto AP.

Additional features will be set forth in the following description, and in part will be even more apparent from the examples set forth, or may be learned by practice of exemplary embodiments.

According to an aspect of an exemplary embodiment, there is provided a method for automatically setting an area code by a femto AP located in a coverage area of a macro cell, including receiving a broadcast signal of the macro cell, extracting an area code of the macro cell from the received broadcast signal, and setting the extracted area code as an area code of the femto cell.

According to an aspect of another exemplary embodiment, there is provided a femto AP located in a coverage area of a macro cell, including a receiving unit to receive a broadcast signal of the macro cell, an extracting unit to extract an area code of the macro cell from the received broadcast signal, and a setting unit to set the extracted area code as an area code of a femto cell.

### ADVANTAGEOUS EFFECTS

According to the present invention, a femto access point (AP) searches for an area code of a neighboring macro cell and sets the found area code as its area code at the initial installation, thereby preventing a mobile station from repeating the location registration, resulting in network load reduction and ensuring the stability of a communication system.

### DESCRIPTION OF THE DRAWINGS

FIG. 1 is a schematic diagram illustrating a network configuration of a mobile communication system including a femto cell.

FIG. 2 is a diagram illustrating a configuration of a femto access point (AP) according to an embodiment of the present invention.

FIG. 3 is a signal flowchart illustrating a method for setting an area code by a femto AP according to an embodiment of the present invention.

### DETAILED DESCRIPTION

Hereinafter, the present invention will be described in detail. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation.

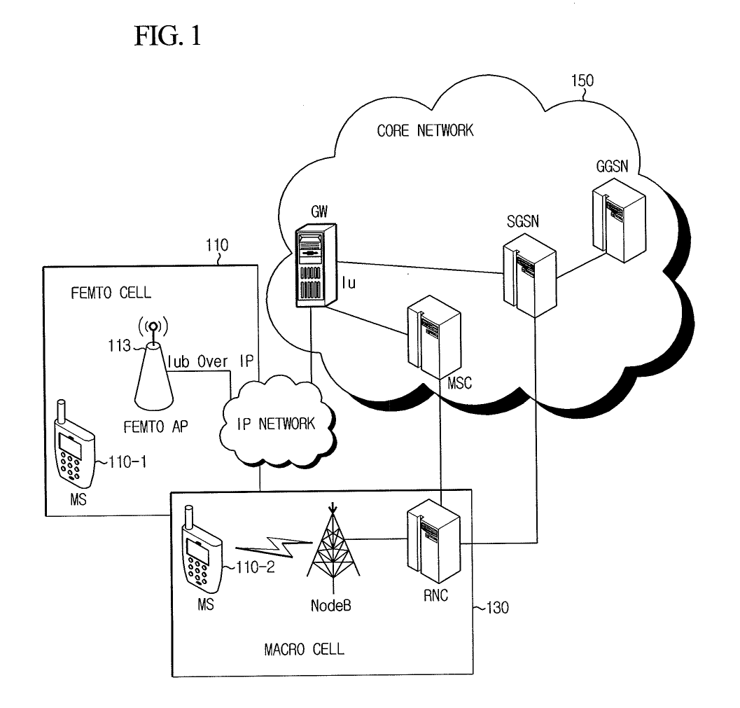

FIG. 1 is a schematic diagram illustrating a network configuration of a mobile communication system including a femto cell.

Referring to FIG. 1, the mobile communication system includes a femto cell 110, a macro cell 130, and a core network 150. Although the femto cell 110 and the macro cell 130 are illustrated as being separate from each other, the femto cell 110 is located within a coverage area of the macro cell 130.

The macro cell 130 is a general radio access cell of a mobile communication system, and includes a base station (base transceiver station (BTS), Node-B) that manages the radio resources, and a base station controller (BSC) equivalent radio network controller (RNC) that controls the Node-B. The macro cell 130 makes a wireless communication with a mobile station 110-2 to provide a mobile communication service to the mobile station 110-2.

The femto cell 110 includes a femto AP 113 connected to a universal Internet line (IP network). When a mobile station 110-1 enters a coverage area of the femto cell 110, the mobile station 110-1 connects to the femto AP 113, which then connects to the core network 150 via the femto AP 113 through the universal Internet line. Generally, the femto cell 110 supports one frequency, and may use a different frequency from that of the macro cell 130 to reduce the interference with the macro cell 150. Also, since the femto AP 113 of the femto cell 110 has a small coverage area, the femto AP 113 supports a small number of simultaneous users, generally four.

The femto AP 113 of the femto cell 110 can also be called a pico AP, a ubicell AP, and the like, depending on the policy of a manufacturer or a communication service provider. Likewise, the femto cell 110 is also called a pico cell, ubicell, and the like. In exemplary embodiments, the femto cell 110 is not specially limited if it is connected to the core network 150 of the mobile communication system via a universal Internet line to provide a mobile station with a mobile communication service.

At the initial installation, the femto AP 113 operates to receive a broadcast signal broadcast from the macro cell 130, and extracts an area code included in the signal. Also, the femto AP 113 sets the same area code as the extracted area code as its area code. The area code includes a location area code (LAC) and a routing area code (RAC). The LAC is used for paging in a circuit switching domain, and the RAC is used for paging or registering in a packet switching domain.

The femto AP 113 transmits the set area code to the mobile station 110-1 by using a broadcast signal. The broadcast signal is system information block type 1 in a wideband code division multiple access (WCDMA) system.

An example of a format of the system information block type 1 is as below:

cn-CommonGSM-MAP-NAS-SysInfo ‘0C03’H,

cn-DomainSysInfoList

cn-DomainIdentity cs-domain,

cn-Type gsm-MAP: ‘1401’H,

cn-DRX-CycleLengthCoeff 6,

cn-DomainIdentity ps-domain,

cn-Type gsm-MAP: ‘0100’H,

cn-DRX-CycleLengthCoeff 6

As seen above, a LAC is 1401(H), and a RAC is 0100(H).

After the femto AP 113 sets the same area code as that of the macro cell 130, the femto AP 113 transmits the set area code to the mobile station 110-1 by using a broadcast signal, and also transmits the set area code to a gateway (GW) that connects the femto AP 113 to the core network 150. That is, the femto AP 113 makes an assignment request for the set area code to the gateway.

The gateway implements the same paging as in the macro cell 130 by using the received area code. The gateway shares an area code list with a mobile switching center (MSC) (including serving GPRS support node (SGSN)) of the core network 150, and when the area code transmitted/reported by the femto AP 113 is absent in the list, the gateway transmits a negative acknowledgement (NACK) response to the area code assignment request to the femto AP 113. Also, the gateway transmits an area code among area codes included in the list to the femto AP 113.

The core network 150 is a network of a mobile communication system for providing a data service and a voice service, and is connected to the macro cell 130 via the MSC or SGSN and to the femto cell 110 via the IP network and the gateway, to provide a mobile communication service to the mobile station 110-1 within the macro cell 130 or the femto cell 110.

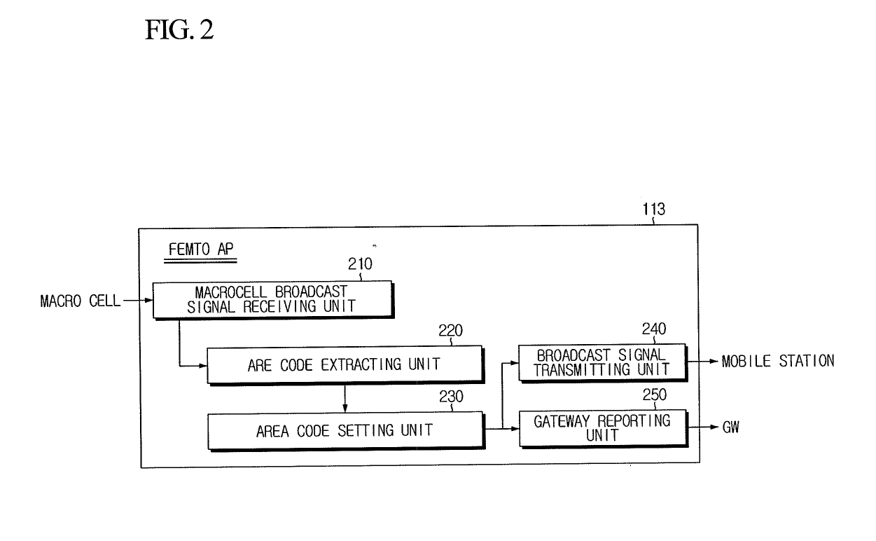

FIG. 2 is a diagram illustrating a configuration of the femto AP 113 according to an embodiment of the present invention. In the present exemplary embodiment, a typical function of the femto AP 113 is omitted.

As shown in FIG. 2, the femto AP 113 includes a macrocell broadcast signal receiving unit 210, an area code extracting unit 220, an area code setting unit 230, a broadcast signal transmitting unit 240, and a gateway reporting unit 250.

The macrocell broadcast signal receiving unit 210 operates to receive a broadcast signal broadcast from the macro cell 130 at the initial installation of the femto AP 113. The broadcast signal is transmitted via a broadcast control channel (BCCH).

The area code extracting unit 220 extracts an area code, that is, a LAC or a RAC, from system information block type 1 included in the broadcast signal received by the macrocell broadcast signal receiving unit 210.

The area code setting unit 230 stores the area code extracted by the area code extracting unit 220 in a system data storage area of a memory. Accordingly, the same area code of the macro cell is set in the memory of the femto AP 113.

In this instance, when the area code setting unit 230 receives a NACK response to the setting of the extracted area code from the gateway, the area code setting unit 230 stores an area code assigned by the gateway in the memory.

The broadcast signal transmitting unit 240 transmits the area code set by the area code setting unit 230 as a broadcast signal via a BCCH. The area code transmitted by the broadcast signal transmitting unit 240 is used for location registration or neighbor list registration in the mobile station 110-1.

The gateway reporting unit 250 reports the area code set by the area code setting unit 230 to the gateway that connects the femto AP 113 to the core network 150. The gateway implements paging based on the reported area code of the femto AP 113, when delivering a call.

In this instance, the gateway reporting unit 250 receives an ACK or NACK response to the setting of the reported area code from the gateway, and transmits the result to the area code setting unit 230. When the gateway reporting unit 250 receives a NACK response, the gateway reporting unit 250 receives the area code assigned by the gateway from the gateway, and transmits the received area code to the area code setting unit 230 to enable the area code setting unit 230 to set the area code.

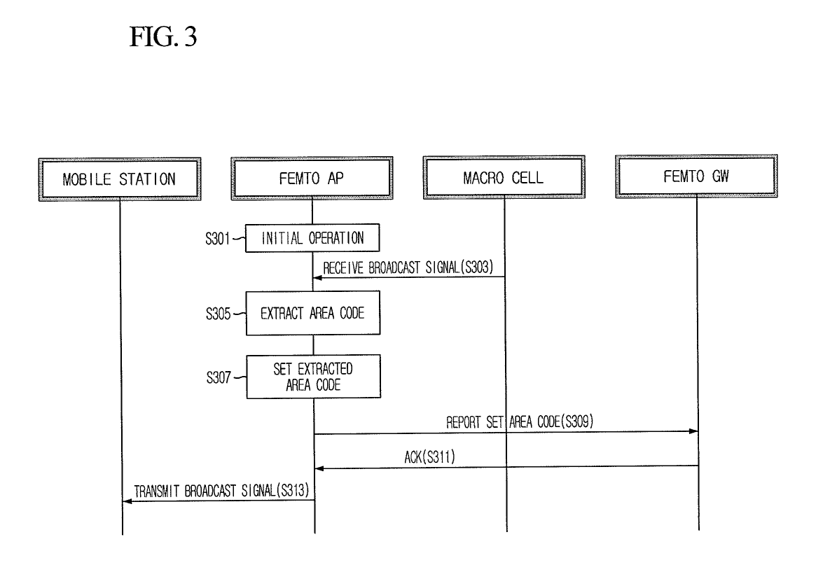

FIG. 3 is a signal flowchart illustrating a method for setting an area code by the femto AP 113 according to an embodiment of the present invention.

Referring to FIG. 3, in step S301, the femto AP 113 operates by an input of a user at the initial installation. In step S303, the femto AP 113 receives a broadcast signal broadcast from the macro cell 130 upon operation. The broadcast signal is transmitted via a BCCH.

In step S305, the femto AP 113 extracts an area code of the macro cell 130, that is, a LAC or a RAC, from system information block type 1 included in the received broadcast signal.

In step S307, the femto AP 113 stores and sets the extracted area code in a system data storage area of a memory. Accordingly, the same area code of the macro cell is set in the memory of the femto AP 113.

In step S309, the femto AP 113 reports the set area code to the gateway that connects the femto AP 113 to the core network 150. In step S313, the gateway compares the area code reported from the femto AP 113 with an area code list shared with the MSC of the core network 150, and when the reported area code is present in the list, the gateway transmits an ACK response to the femto AP 113.

After the femto AP 113 receives the ACK response, the femto AP 113 transmits the set area code as a broadcast signal to the mobile station 110-1 via a BCCH. The area code included in the broadcast signal transmitted by the femto AP 113 is used for location registration or neighbor list registration in the mobile station 110-1.

On the contrary, when the area code reported from the femto AP 113 is absent in the area code list shared with the MSC of the core network 150, the gateway assigns an area code and transmits the assigned area code to the femto AP 113 along with a NACK response to set the area code. Accordingly, the area code set in the femto AP 113 is synchronized with the core network 150.

As described above, the femto AP 113 sets the same area code as that of the macro cell 130 at the initial installation, and transmits the area code to the mobile station 110-1 while carrying the area code on a broadcast signal. Accordingly, the mobile station 110-1 receives the same area code within a coverage area of the macro cell 130 or the femto cell 110, and thus, the mobile station 110-1 does not need to perform the location registration that had been repeated cumbersomely when the mobile station 110-1 moves from the macro cell to the femto cell, or vice versa. Also, since the area code of the femto AP 113 is the same as that of the macro cell 130, the mobile station 110-1 receives the same paging message from the femto AP 113 and the macro cell 130.

Accordingly, in an aspect of a communication network, the repeated location registration of the mobile station 110-1 is eliminated, thereby achieving the network load reduction. Also, since a coverage area of the femto cell 110 overlaps with a coverage area of the macro cell 130, the mobile station 110-1 may be located in the boundary of the femto cell 110 and the macro cell 130. However, since the femto AP 113 and the macro cell 130 have the same area code as described above, the mobile station 110-1 receives the same paging message. Accordingly, in the neighborhood of the femto cell 110, a call drop may be prevented and the possibility that the mobile station 110-1 will succeed to receive a call may increase.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or variation of a subcombination.

Although the drawings describe the operations in a specific order, one should not interpret that the operations are performed in a specific order as shown in the drawings or successively performed in a continuous order, or that all the operations need to be performed to obtain a desired result. Multitasking or parallel processing may be advantageous under any environment. Also, it should be understood that all exemplary embodiments do not require the distinction of various system components made in this description. The program components and systems may be generally implemented as a single software product or multiple software product packages.

A method of one or more exemplary embodiments may be recorded in non-transitory computer-readable media (CD ROM, random access memory (RAM), read-only memory (ROM), floppy disks, hard disks, magneto-optical disks, and the like) including program instructions to implement various operations embodied by a computer.

Only a few implementations and examples are described and other implementations, enhancements and variations can be made based on what is described and illustrated in this application.

What is claimed is:

1. A method for automatically setting an area code by a femto access point (AP) located in a coverage area of a macro cell, the method comprising:
receiving a broadcast signal of the macro cell;
extracting an area code of the macro cell from the received broadcast signal; and
setting the extracted area code as an area code of the femto cell.

2. The method according to claim 1, further comprising:
reporting the set area code to a gateway connected to a core network of a communication system.

3. The method according to claim 2, further comprising:
receiving a negative acknowledgement (NACK) response to the report of the area code and an area code assigned by the gateway from the gateway; and
setting the area code assigned by the gateway as an area code of the femto cell.

4. The method according to claim 1 or 2, further comprising:
transmitting a broadcast signal including the set area code to a mobile station located in a coverage area of the femto cell.

5. The method according to claim 1 or 2,
wherein the area code includes a location area code (LAC) and a routing area code (RAC).

6. A femto access point (AP) located in a coverage area of a macro cell, comprising:
a receiving unit to receive a broadcast signal of the macro cell;
an extracting unit to extract an area code of the macro cell from the received broadcast signal; and
a setting unit to set the extracted area code as an area code of a femto cell.

7. The femto AP according to claim 6, further comprising:
a reporting unit to report the area code to a gateway connected to a core network of a communication system.

8. The femto AP according to claim 6 or 7, further comprising:
a transmitting unit to transmit a broadcast signal including the set area code to a mobile station located in a coverage area of the femto cell.

9. The femto AP according to claim 6 or 7,
wherein the area code includes a location area code (LAC) and a routing area code (RAC).

10. The femto AP according to claim 6 or 7,
wherein the receiving unit receives the broadcast signal of the macro cell upon initial operation of the femto AP.
